(19) United States
(12) Patent Application Publication
(10) Pub. No.: US 2026/0281760 A1
(43) Pub. Date: Sep. 17, 2026

(54) RADIO ACTIVITY DETECTION IN WIRELESS NETWORKS

(71) Applicant: DeepSig Inc., Arlington, VA (US)

(72) Inventors: Peter Carson, Arlington, VA (US); Timothy James O'Shea, Arlington, VA (US); Timothy Newman, Edgewater, MD (US); Jacob Gilbert, Albuquerque, NM (US)

(21) Appl. No.: 19/310,031

(22) Filed: Aug. 26, 2025

Related U.S. Application Data
(60) Provisional application No. 63/686,918, filed on Aug. 26, 2024.

(51) Int. Cl. H04W 24/08; H04W 16/14

(52) U.S. Cl. CPC H04W 24/08; H04W 16/14

(57) ABSTRACT

Methods, systems, and apparatus, including computer programs encoded on computer storage media, for radio activity detection, e.g., in wireless networks. One of the methods includes detecting one or more signals based on one or more outputs generated by one or more trained machine learning models processing information corresponding to a complex baseband representation of a received RF data.

### CROSS-REFERENCE TO RELATED APPLICATIONS

This application claims priority from U.S. Provisional Application No. 63/686,918, filed on Aug. 26, 2024, entitled “Spectrum Sensing for Wireless Communications using Artificial Intelligence Tools”, which is herein incorporated by reference in its entirety.

### TECHNICAL FIELD

This specification relates to detecting radio activity in wireless networks, e.g., sensing wireless frequency bands to detect radio frequency (RF) signals.

### BACKGROUND

In wireless communications systems, e.g., based on European Telecommunications Standards Institute (ETSI) Third Generation Partnership Project (3GPP) 4^{th} Generation Long Term Enhancement (4G LTE), 5^{th} Generation New Radio (5G-NR), 6^{th} Generation (6G) networks, Wi-Fi networks, and/or Bluetooth networks, the frequencies, bandwidths and timeslots can be pre-coordinated. Both the transmitter and receiver can have bands allocated to them and be provided with information indicating where to find a signal in the spectrum. This allows the receiver to focus on specific frequency bands and specific protocols (e.g. preambles) for signal detection.

Wireless reception can degrade due to interference signals, e.g., signals that interfere with the reception of one or more desired signals. When interference signals impair reception, the signals often do not follow the same predictable patterns (e.g., the signals can occur randomly in time and frequency) and can be difficult to identify.

### SUMMARY

This specification describes technologies for detecting radio activity in wireless networks. These technologies generally involve processing received radio signal information using one or more machine learning (ML) models. Output from the processing can be used to detect radio activity, including one or more wireless signals. Detected signals can be represented graphically or otherwise to enable various sensing-based applications. Detected signals can be used as triggers to implement various interference mitigation or coexistence mechanisms—e.g., to enable more efficient sharing of limited RF spectrum for communication signals.

Detecting radio activity can include spectrum sensing. Data from spectrum sensing, which can be referred to as spectrum awareness, can enable or enhance a range of applications, such as spectrum sharing and mapping, fault detection, or security and regulatory monitoring. Techniques can include ML based signal detection and classification. Techniques can improve at least one of the speed, accuracy, sensitivity, power consumption, cost, computational load, or ease of building and deploying a wide range of sensing systems, e.g., at the edge for a diverse set of use cases. ML based signal detection and classification methods can be data driven. ML based signal detection and classification methods can be updated to accommodate new signals or type of emitters or interference. ML based signal detection and classification methods can be improved over time. ML based signal detection and classification methods can be updated, e.g., for what they may need to encounter in the environment. ML based signal detection and classification methods can be updated over time to refine their performance, e.g., for evolving new use cases. Some traditional spectrum sensing approaches can perform analytic feature driven processing stages which can be computationally heavy. Computer load can be traded off with sensitivity—e.g., cyclostationary approaches, energy detection, or moment-based methods. The described ML processes can excel at various tasks, such as interferer or signal-on-signal detection, or joint detection-classification-and-localization type approaches. Some traditional spectrum sensing approaches can struggle, particularly with these tasks. Some traditional spectrum sensing systems expected a specialized signal or type of signal. The described ML based signal detection and classification methods allows for broader analytics of emitters compared to some traditional systems. The described methods can be more computationally efficient—allowing for signal data to be converted into metadata and event data for subsequent processes, such as transmission, storage, analytics, or reaction with, e.g., at least one of greater accuracy, efficiency, and greater signal or signal type coverage.

A sensing system can detect radio activity within a frequency spectrum. Radio activity can include attacks, such as wireless spoofing, jamming, or injection where malicious entities attempt to manipulate or disrupt a wireless system. Attack signals can be similar or indistinguishable from a legitimate signal—e.g., transmitting data from one component to another for a non-attack purpose. Attack signals can pose time-sensitive threats that, if not detected rapidly, can result in various systems becoming compromised or inoperable.

The sensing system can be employed to more efficiently utilize available RF spectrum—e.g., by detecting one or more signals and adjusting subsequent transmissions to avoid, or make use of, specific frequencies based on the detections. Dynamic allocation of RF usage based on detections of a sensing system can increase capacity of the finite RF spectrum. Dynamic allocation can be paired with other methods to increase capacity, such as air interface upgrades and cell site and antenna densification (e.g., small cells and massive multiple-input and multiple-output (MIMO)). Increasing capacity can allow a greater number of communication signals to be transmitted at any given time which can allow more people to communicate with fewer instances of signal interference or disrupted signals. This can help solve the growing issue of spectrum shortages in telecommunications—e.g., where there is not enough space within a given range of electromagnetic energy to send enough signals for all devices requesting to do so at a given time.

The disclosed techniques can improve the sharing of limited RF spectrum across different wireless networks by being able to detect a wide variety of signals that may be transmitted at low power. For example, techniques described can be used for spectrum sharing of 3GPP 4G, 5G, 6G and future systems, e.g., that use RF spectrum including spectrum between 3.1 and 3.45 GHz. Techniques can include a distributed sensing system that can be deployed alongside radio infrastructure. The system can be capable of identifying a wide range of waveforms and protocols—e.g., to improve spectrum sharing. Wireless devices are running out of fresh dedicated spectrum to be allocated per operator or wireless system. Techniques described can be used to more efficiently make use of available RF spectrum—e.g., by allocating signals to portions of RF spectrum assigned to one or more other protocols or devices at times when those other protocols or devices are not using all or some of their assigned RF spectrum. The disclosed techniques can be used for a broad range of spectrum bands, e.g., to allow for devices to operate in spectrum which is not fully utilized. A non-exhaustive list of bands which can be allocated to one or more devices to improve efficiency of RF spectrum sharing can include FR1: 470-698 MHz, 600/700/800 MHz bands, 1.8 GHz, 2.1 GHz, 2.6 GHz, 3.1-3.45 GHz, 3.5-3.7 GHz, 4.4-4.94 GHz, 5.15-5.925 GHz 5.925-7.125 GHz over which some diverse types of systems operate such as existing broadcast, 2G/3G/4G/5G bands and other communications and sensing systems but do not fully utilize the spectrum. FR2: 24.25-24.45 GHz, 24.75-25.25 GHz, 24.25-27.5 GHz, 27.5-29.5 GHz, 37-37.6 GHz, 51-71 GHz where many existing systems such as weather radars operate but do not fully utilize the spectrum and its capacity. FR3: 7.125-8.4 GHz, 10-10.7 GHz, 12.7-13.25 GHz, 13.75-14.5 GHz, 15.35-17.3 GHz, 18-20 GHz where a diverse set of uses exist such as fixed services, satellite services, passive sensors, among other use cases that make use of bits of spectrum but are not fully utilizing the RF spectrum capacity.

In general, one innovative aspect of the subject matter described in this specification can be embodied in methods that include the actions of processing information corresponding to a complex baseband representation of a received RF data using one or more trained machine learning models; obtaining one or more outputs generated by the one or more trained machine learning models based at least on processing the information corresponding to the complex baseband representation of the received RF data; and detecting one or more signals based on the one or more outputs generated by the one or more trained machine learning models. Actions can be performed by at least one of a radio unit, a distributed unit, a control unit, a radio access network intelligent controller, or a service management and orchestration element. Embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. Feature 1: Actions include, in response to detecting the one or more signals based on the one or more outputs generated by the one or more trained machine learning models, adjusting operation of one or more elements within a communication network. Feature 2: Adjusting operation of the one or more elements within the communication network includes performing one or more interference mitigation or coexistence mechanisms. Feature 3: Adjusting operation of the one or more elements within the communication network includes adjusting a transmitting or receiving device that transmits or receives data within FR1, FR2, or FR3. Feature 4: Actions include providing a visual or non-visual representation of the detected one or more signals to one or more devices that are communicably coupled to at least one of the radio unit, the distributed unit, the control unit, the radio access network intelligent controller, or the service management and orchestration element. Feature 5: Providing the visual representation of the detected one or more signals to the one or more devices includes: presenting, on a graphical user interface of the one or more devices, numerical or non-numerical indicators of the detected one or more signals. Feature 6: Presenting on the graphical user interface of the one or more devices the numerical or non-numerical indicators of the detected one or more signals includes: displaying, on the graphical user interface, an image that includes a region with indicators situated within the region corresponding to at least one of the detected one or more signals. Feature 7: Providing the visual representation of the detected one or more signals to the one or more devices includes: providing an estimated spatial location of a transmitting device that transmitted at least one of the detected one or more signals. Feature 8: Providing the estimated spatial location of the transmitting device that transmitted at least one of the detected one or more signals includes: providing the estimated spatial location as an indication to an augmented or virtual reality wearable device. Feature 9: Actions include, in response to detecting the one or more signals based on output of the one or more trained machine learning models processing the complex baseband representation of the received RF data, controlling access to one or more wireless networks or devices. Feature 10: Actions include, in response to detecting the one or more signals based on output of the one or more trained machine learning models processing the information corresponding to the complex baseband representation of the received RF data, generating and transmitting one or more alerts to a connected device. Feature 11: Actions include detecting one or more of angle of arrival or timing information of the detected signals based on the one or more outputs generated by the one or more trained machine learning models processing the information corresponding to the complex baseband representation of the received RF data. Feature 12: Actions include determining that the detected one or more signals correspond to unauthorized signals; and in response to determining that the detected one or more signals correspond to unauthorized signals, detecting one or more of angle of arrival or timing information of the detected signals based on the one or more outputs of the one or more trained machine learning models processing the information corresponding to the complex baseband representation of the received RF data. Feature 13: Actions include providing information corresponding to a location or environment; and in response to providing the information corresponding to the location or environment, receiving an update that corresponds to the location or environment from a stored database of model updates. Feature 14: The radio unit is configured to generate an in-phase and quadrature data stream as the information corresponding to the complex baseband representation of the received RF data.

An innovative aspect of the subject matter described in this specification can be embodied in methods that include the actions of detecting RF data; providing the RF data to an analog-to-digital converter; providing output of the analog-to-digital converter to a digital tuner; providing at least one of (i) the output of the analog-to-digital converter or (ii) output of the digital tuner to one or more machine learning models; in response to providing at least one of (i) the output of the analog-to-digital converter or (ii) output of the digital tuner to the one or more machine learning models, obtaining one or more outputs generated by the one or more machine learning models; and detecting one or more signals based on the one or more outputs generated by the one or more machine learning models processing at least one of (i) the output of the analog-to-digital converter or (ii) the output of the digital tuner.

Actions can be performed by at least one of a radio unit, a distributed unit, a control unit, a radio access network intelligent controller, or a service management and orchestration element. Embodiments of this aspect include corresponding computer systems, apparatus, and computer programs recorded on one or more computer storage devices, each configured to perform the actions of the methods.

The technologies described in this specification can be implemented so as to realize one or more of the following advantages. For example, by using one or more machine learning (ML) models, a system can detect a wider array of different signals across a wider range of RF spectrum compared to traditional detection processes. These detections can enable more efficient spectrum sharing—e.g., by implementing various interference mitigation or coexistence mechanisms in response to detecting one or more signals that satisfy a sharing threshold. Detections can also be used for other sense-based applications, such as visualizing locations of transmitters—e.g., to enable rapid technician deployment to identify emitters that can decrease or at least partially limit communications within a given area.

By allowing sensing in the RAN to detect emitters around network elements, e.g., and to turn their detection into structured metadata or event data (e.g. SigMF data), a system can generate compact data. Compact data can be used in a variety of ways, such as to enable RAN Digital Twin activity tracking and analytics, fusion between multiple RAN network elements or base station sectors, fusion between different modalities (e.g. ISAC style active-radar sensing returns/reflections off objects, passive ISAC radar reflections from other known emitters such as broadcast towers, entities emitting RF emissions or signatures of certain types, objects detected vie electro-optical, lidar, acoustic, or other domains). One or more of these methods of detection can be combined in an integrated sensing and communication ISAC deployment. The deployment can maintain awareness of one or more activities, objects, emitters, or other events occurring around the RAN. These can include things like drone detection/tracking, vehicle or human detection/tracking, navigation, gesture recognition, fall/accident detection, environmental threat detection. Awareness of the deployment can be used for a wide range of entertainment, crowd analytics, gaming, or other applications. For each of these, since sensing is distributed, turning it into compact structured metadata early for diverse detections and modalities, allows for transport, fusion, tracking, analytics, coordination, and/or sharing of this information on and between network elements.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example signal detecting system.

FIGS. 2-4 shows a subset of the options A-E for implementing a sensing engine being operated by one or more elements of the system.

FIG. 5 shows an example process flow of integrating RF sensing in an RU receiving path.

FIG. 6A-F show various a graphical user interfaces (GUIs).

FIG. 7 shows an example system for updating one or more ML models.

FIG. 8 show processes for signal detection.

FIGS. 9-10 are flowcharts of example processes for detecting signals.

Like reference numbers and designations in the various drawings indicate like elements.

### DETAILED DESCRIPTION

The disclosed techniques can include detecting wireless radio activity in one or more wireless frequency bands by sensing the frequency band spectrum. Data from spectrum sensing, which can be referred to as spectrum awareness, can enable or enhance a range of applications from spectrum sharing and mapping, to fault detection, security and regulatory monitoring. Machine learning (ML) based signal detection and classification, which can include Artificial intelligence (AI), can improve at least one of the speed, accuracy, sensitivity, or ease of building and deploying a wide range of sensing solutions, e.g., at the edge for a diverse set of use cases.

Some network-based monitoring primarily detect degradation in key performance indicators (KPIs) such as throughput or received signal quality degradation. Such monitoring can point to a vague problem or unexplained cause. Dispatching technicians for an on-site diagnosis with test and measurement equipment can take time, be costly, and unreliable, particularly for intermittent emissions that may not occur predictably or during a site visit.

Radio spectrum awareness can be useful in a variety of different environments, e.g., where securing communication channels or preventing unwanted surveillance is important. Certain events can indicate attacks such as wireless spoofing, jamming, or injection. Attacks can include malicious entities attempting to manipulate or disrupt a wireless system. In some cases, an attack signal can be virtually indistinguishable from a legitimate signal, but may require instantaneous detection, classification, and mitigation, which leaves little or no time for human-in-the-loop analysis or reaction time. Similarly, protection from unwanted surveillance by drones or other nearby communications systems can require an ability to reliably detect or identify potentially threatening communications emissions, rapidly recognizing or localizing nearby potential threats.

The disclosed techniques can include RF spectrum sharing. Radio frequency (RF) spectrum is a finite and often inefficiently used resource. Mobile network operators (MNOs) can use large swaths of bandwidth in the RF spectrum. As frequencies become congested with traffic, capacity can be added through air interface upgrades and cell site and antenna densification (e.g., small cells and massive MIMO). Such mitigation can provide temporary relief. There is a looming shortage of electromagnetic spectrum for use to transfer the ever-increasing numbers of wireless signals in the modern world.

In an attempt to increase bandwidth of the limited RF spectrum, communications can use other frequencies. However, using other frequencies can increase a likelihood that one or more communicating entities will issue communications that conflict—e.g., are sent within the same frequency in a manner that makes receiving of such signals difficult or impossible. The disclosed techniques include processes to efficiently detect one or more signals. After detection, a process can include controlling one or more receivers or transmitters to adjust a receiving or transmitting process—e.g., to account for a detected or expected signal conflict. Conflict can relate to at least one of the following: co-channel or adjacent channel interference, intermodulation interference, receiver desensitization, hidden node problems, or frequency hopping collisions.

Techniques can be used for detecting well-defined signals or detecting multiple or unknown signals across an RF spectrum. In some cases, detecting multiple or unknown signals across an RF spectrum can be more difficult than detecting well-defined signals because well-defined signals can have known parameters, such as frequency, modulation scheme, bandwidth, or timing and synchronization. Receivers of well-defined signals can be precisely tuned or optimized to detect and decode these signals with high sensitivity and low error rates. Well-defined signals can be narrowband which allows any detection to amplify or reduce noise of the signal and process the signal using one or more tuned receivers. When detecting signals within a broader RF spectrum, it can be a challenge to process different bands while exceeding processing bandwidth or energy constraints of a given receiving system. The techniques described herein can improve detection of radio activity, including detection of well-defined or signals within an RF spectrum, e.g., by using one or more ML models trained to detect one or more signals.

The disclosed techniques can include an Open RAN (ORAN) implementation of a distributed spectrum sensing system, e.g., in a 5G network. A system can provide an architecture to build applications, such as spectrum sensing, which can leverage standard interfaces and service models to seamlessly integrate and interoperate across different Radio Access Network (RAN) vendor platforms. The system can use an ORAN architecture to enable flexible placement of sensing functions, in, e.g., an Open Radio Unit (O-RU), Open Distributed Unit (O-DU) or a RAN Intelligent Controller (RIC) running as an embedded function or as software application (e.g., dApp, rApp or xApp) at the edge. In some cases a virtualized RAN (vRAN) can include a similar architecture, e.g., without being fully ORAN compliant. A Radio Unit (RU) can be equivalent to the O-RU, a distributed unit (DU) can be called a baseband unit (BBU) or similar in some cases, and the radio intelligent controller (RIC) can include vendor services, e.g., in their own SMO or backend network (e.g. vendor Apps or other Apps which can take the place of xApps and rApps). In some cases, the sensing function can be performed in a software defined radio (SDR) component within the O-RU. Different implementation options can have a different set of fronthaul bandwidth, compute, performance, or scalability tradeoffs.

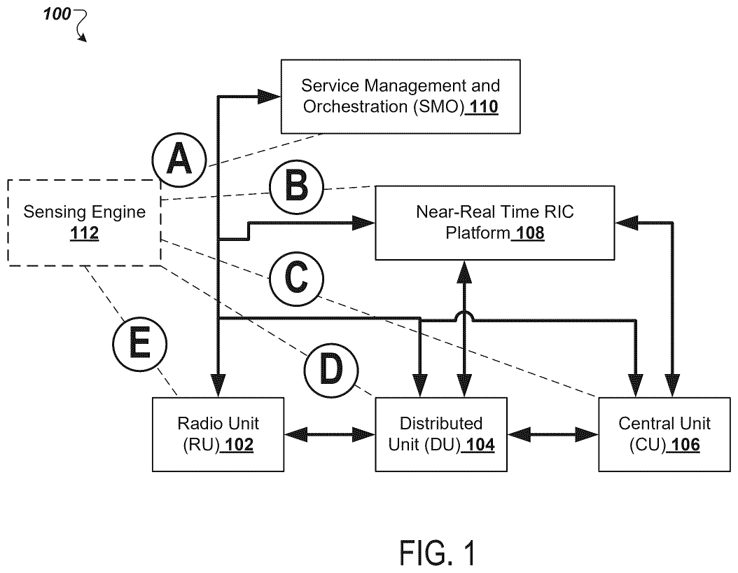

FIG. 1 shows an example signal detecting system 100. The system 100 includes a radio unit (RU) 102, a distributed unit (DU) 104, a central unit (CU) 106, a near-real time RAN Intelligent Controller (RIC) platform 108, and a service management and orchestration (SMO) element 110.

The RU 102 can capture and transmit one or more RF signals. The DU 104 can process the RF signals. The CU 106 can handle higher-layer processing or connect to another network. The RIC 108 can perform control, e.g., by sending control policies or optimization commands to the DU 104 and CU 106 using an interface, such as an E2 interface. The SMO 110 can help manage the system 100, e.g., coordinating deployment, updates, or fault management.

The system 100 includes a sensing engine 112. The sensing engine 112 can be operated by one or more elements of the system 100, such as the RU 102, the DU 104, the CU 106, the RIC 108, or the SMO 110. Implementation options include options A-E, where each of the options A-E includes the sensing engine 112 being operated by one or more elements of the system 100, such as the RU 102, the DU 104, the CU 106, the RIC 108, or the SMO 110. The sensing engine 112 can include one or more ML models trained to detect one or more signals based on processing information corresponding to a complex baseband representation of received RF data, e.g., from one or more receiving antennas or other elements.

The sensing engine 112 can perform inferencing on components of a received radio signal, e.g., received by the RU 102. The components can include one or more of: in-phase and quadrature (IQ) components of a radio signal; an RF envelope that represents amplitude of an RF signal over time; a magnitude or phase of an RF signal; a Fourier transform of a radio signal; one or more raw voltage values of an RF signal; symbol data representing decoded digital symbols of an RF signal; a constellation diagram of an RF signal; a spectrogram representing an evolution of a spectrum over time; or a combination of these among others.

The sensing engine 112 can detect or classify one or more received signals. The sensing engine 112 can generate and transmit data for processing by one or more other elements of the system 100, e.g., the RU 102, the DU 104, the CU 106, the RIC 108, or the SMO 110. In some cases, the sensing engine 112 generates metadata by processing one or more components of a received RF signal. The metadata can be provided to another processing element, such as an xApp.

In some implementations, the sensing engine 112 is operated by the RU 102. In some cases, an xApp can be run in the RIC 108, e.g., in cases where the sensing engine 112 is operated by the RU 102 or in other cases. The xApp can perform one or more operations, e.g., post-processing of data received by the sensing engine 112, determining actionable events, or initiating mitigation mechanisms. Actions or mitigation mechanisms can include at least one of: tracking emitters or their power or behavior over time, combining observations from multiple sectors to provide improved awareness or localization, combining observations with other ISAC observations to provide entity detection or tracking, providing analytics on these entities over time, detection of anomalies, threats, or network failures, detection of interference from within or out of network, feeding items such as a RAN Digital Twin that can maintain an operating picture of the stable propagation properties of a RAN and/or the presence or movement of objects, emitters or entities as they move around the physical world near the RAN. In some cases, these may be provided to external subscribers such as users that seek awareness, analytics, tracking, security, or a combination of these (e.g., a telecommunication service team or local police force). A system of the disclosed techniques, which can include an xApp, can determine actions to perform. The system can aggregate observation metadata or detection event data over time. The system can detect or process a distribution of aggregated data. The system can process data to determine, e.g., whether new modes emerge, change, or fade. The system can have one or more rules, e.g., that indicate types of signals or combine types of signals to estimate properties, such as the physical world objects that generated them. In some cases, various statistical processing, such as density estimation or out-of-distribution detection, can be performed on event data. A rule or threshold can be used, e.g., to detect or determine one or more actions to perform. In some cases, tools such as large-language models (LLMs) or agentic-AI—e.g. RAN agents that can adjust or detect one or more parameters on the RAN backend, informed by sensing metadata, experience, and/or key performance indicator (KPI) impact—can leverage structured RF metadata, e.g., to detect or provide output that indicates what is going on in the spectrum, explain or summarize spectrum activity, or provide decision making about the safety, relevance, or cause behind various events or actions to take within the system.

The xApp can include modular applications to perform near-real-time control or optimization of RAN functions. The xApp can include operations for detecting one or more signals. The xApp can include operations for one or more of: radio resource management—e.g., load balancing, interference mitigation; mobility management—e.g., handover optimization; quality of service (QoS) enforcement—e.g., traffic prioritization; energy efficiency—e.g., dynamic cell switching; or ML-based decision making using real-time data from one or more elements of the system 100. The xApp can receive telemetry or performance data from one or more elements of the system 100, such as the DU 104 or the RU 102 using an interface, such as an E2 interface. The xApp can analyze data. The xApp can send control commands back to one or more elements of the system 100, such as the DU 104 or the RU 102. Control commands can be configured to optimize network behavior. The SMO 110 can manage a lifecycle of the xApp, e.g., including deployment, updates, or configuration. In some cases, multiple different xApps can run serially, or at least partially simultaneously, to process or control different aspects of optimization.

In some cases, the RU 102 is connected to at least one of the SMO 110, the RIC platform 108, the DU 104, or the CU 106 using an O1 interface. In some cases, the RU 102 provides or receives data, such as metadata, to or from one or more of the SMO 110, the RIC platform 108, the DU 104, or the CU 106, e.g., using a suitable interface. In some cases, the RU 102 provides data to the DU 104 over an enhanced common public radio interface (eCPRI). In some cases, the DU 104 is connected to the RIC 108 using an interface, such as an E2 interface. In some cases, the CU 106 is connected to the RIC 108 using an interface, such as an E2 interface. In some cases, the RIC 108 is connected to the SMO 110 using an interface, such as an A1 interface. Data can be exchanged between elements of the system 100 using one or more interfaces.

In some cases, the RU 102 can sample a received RF radio signal with a wideband receiver. The RU 102 can use a digitizer to generate a digital representation of the signal. The RU 102 can process one or more components that represent the signal, such as IQ data. In some cases, the RU 102 uses a specialized neural network to process the components. The components can be information corresponding to a complex baseband representation of the received RF data. In cases where the RU 102 operates the sensing engine 112, the RU 102 can be effectively transformed into a spectrum sensor.

The sensing engine 112 can include an ML model, such as a neural network. The ML model can be pre-trained, e.g., on a wide range of signals and conditions. The system 100 can provide the ML model with information corresponding to a complex baseband representation of received RF data. The information can include high-rate (Gbps) IQ data. The sensing engine 112 can detect or classify signals in real time. In some cases, the sensing engine 112 can generate low bandwidth metadata (e.g., in kilobits per second, kbps). The sensing engine 112 can generate a semantic detection of events, such as the sudden appearance of an airborne radar signal. A detection can be transmitted using a suitable interface, such as O1, E2, or other path.

The sensing engine 112 can provide data, e.g., representing one or more detected or classified signals, to other processing elements—such as higher processing layers. The sensing engine 112 can provide data to one or more elements of the system 100, such as the DU 104 or the RIC 108. One or more elements of the system 100 can be configured to initiate interference mitigation or coexistence mechanisms.

Interference mitigation can include one or more of: power control—e.g., adjusting a transmit power to minimize interference to neighboring cells or users; beamforming—e.g., uses antenna arrays to direct signals toward intended users and away from interferers, signaling to other network elements, such as base stations, mobile devices, or other receivers or emitters, to adjust their parameters, such as power, tilt, beams, modulation and/or coding modes, scheduling modes, scheduler settings, MIMO or antenna array settings, or a combination of these among others; frequency planning—e.g., allocating different frequency bands to nearby cells to help avoid overlap; interference cancellation—e.g., using signal processing to subtract or suppress interfering signals, such as successive interference cancellation (SIC) or adaptive filtering; dynamic spectrum access—e.g., selecting frequencies based on detected spectrum availability; scheduling—e.g., allocating time or frequency resources to help minimize overlap; or a combination of these.

Coexistence mechanisms can include one or more of: Listen-Before-Talk (LBT)—e.g., devices can check if a channel is free before transmitting; Time Division Multiplexing (TDM)—e.g., taking turns using spectrum in different time slots; continued monitoring—e.g., devices can monitor an RF environment to detect signals to help avoid collisions; Guard Bands—e.g., including small frequency gaps between channels to help prevent adjacent channel interference; or a combination of these. In some cases, the system 100 can use a spectrum coordination service or spectrum access service (SAS), e.g., similar to that used by the citizens broadband radio service (CBRS) system or by Wi-Fi 8's Multi Access Point Coordination (MAPC). The system 100 can share information with one or more network elements, such as nearby network elements, e.g., to detect, avoid, re-locate, adjust, or optimize coordinated scheduling, frequency assignment, or spatial assignment of future receiving or emissions.

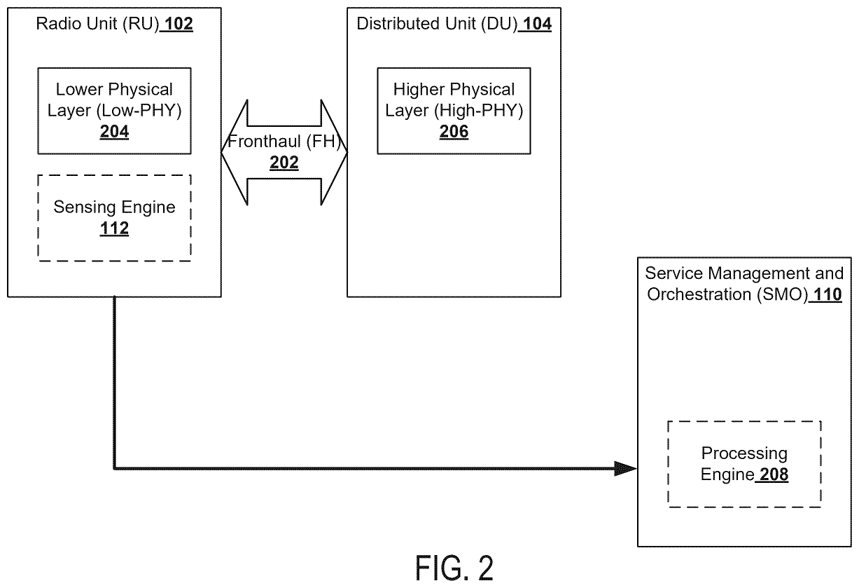

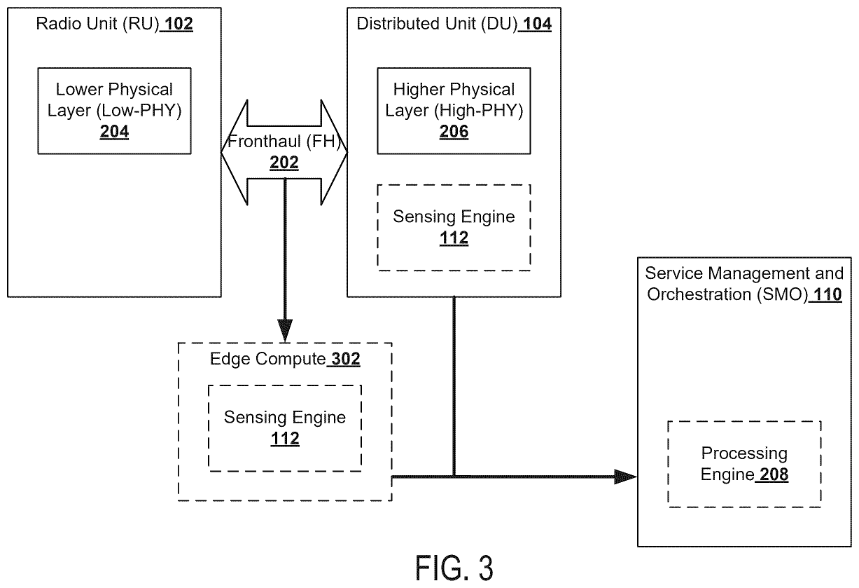

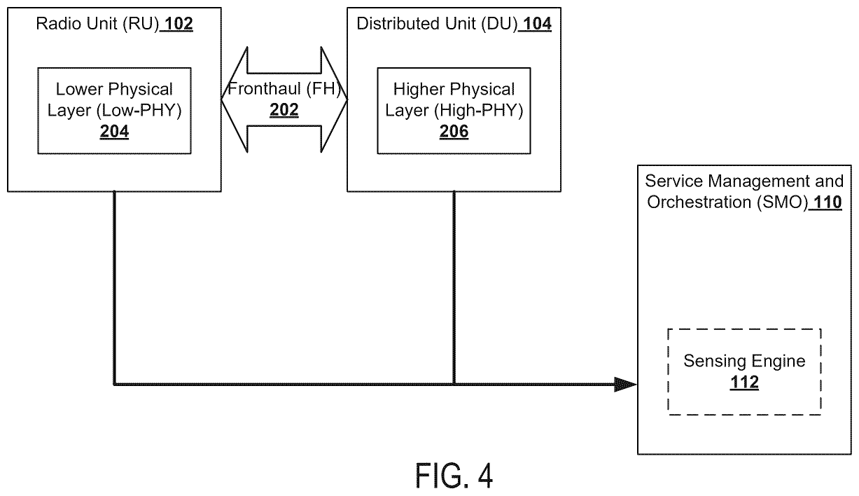

FIGS. 2-4 shows a subset of the options A-E for implementing the sensing engine 112 being operated by one or more elements of the system 100. FIG. 2 shows the sensing engine 112 operated by the RU 102, according to one or more implementations. FIG. 3 shows the sensing engine 112 operated by at least one of the DU 104 or an edge compute 302, according to one or more implementations. FIG. 4 shows the sensing engine 112 operated by the SMO 110, according to one or more implementations.

In each of FIGS. 2-4, a fronthaul (FH) 202 can connect the RU 102 and the DU 104, the RU 102 can operate a lower physical layer (Low-PHY) 204, the DU 104 can operate a higher physical layer (High-PHY) 206, and either, or both, of the RU 102 and the DU 104 can be connected to the SMO 110 using a suitable interface—e.g., O1, E1, or another interface.

The FH 202 can provide a communication link between the RU 102 and the DU 104. The FH 202 can transport at least one of: IQ data, synchronization, or control or management signals. The FH 202 can transport information corresponding to a complex baseband representation of received RF data. The Low-PHY 204 can include operations for preparing signals for transmission or processing received signals—e.g., at least one of digital front-end processing, FFT/IFFT, beamforming, precoding, IQ sample generation, or analog-to-digital or digital-to-analog conversion. The High-PHY 206 can include operations for preparing data for transmission or recovering data from received signals—e.g., at least one of channel coding/decoding, modulation/demodulation, rate matching, hybrid ARQ (HARQ), or scrambling/descrambling.

In FIG. 2, the RU 102 operates the sensing engine 112. The sensing engine 112 can be operated using a variety of different RUs—e.g., from different vendors. The sensing engine 112 can operate using various different splits, e.g., 7.2, 6, 8, 2, or 1. Because the sensing engine 112 can be operated using a variety of different hardware, it can be implemented at a number of different RUs to provide broad spectrum sensing capabilities across a wide area of network usage—e.g., making use of existing system architecture. In some cases, the RU 102 can provide data, indicating one or more detected signals, to the SMO 110 over a suitable interface, such as O1 among others. A processing engine 208 of the SMO 110 can process data provided by the RU 102. The processing engine 208 can, in response to generating output from the processing of the data provided by the RU 102, perform one or more actions. The SMO 110 can perform the one or more actions, e.g., in response to receiving data from the RU 102. The one or more actions can include actions to adjust operation of one or more elements within a network. Adjusting operation of one or more elements within a network can include one or more interference mitigation or coexistence mechanisms.

In FIG. 3, the sensing engine 112 is operated using data provided over the FH 202. The sensing engine 112 can operate on the DU 104, the edge compute 302, or a combination of both. The edge compute 302 can include a server computer, e.g., with access to data of the FH 202. In some cases, the edge compute 302 can augment processing capabilities of the DU 104. For example, by using the edge compute 302 a system can reduce processing requirements of the DU 104 or other element operating the sensing engine 112. The processing can be reduced to nothing—e.g., in cases where the edge compute 302 operates the sensing engine 112 completely—or can be partially reduced—e.g., in cases where the edge compute 302 shares processing tasks of the sensing engine 112 with one or more other elements. Data generated by the sensing engine 112 can be provided to the SMO 110 and the processing engine 208—e.g., using a suitable interface, such as O1. Processing and responsive actions taken by at least one of the SMO 110 and the processing engine 208 can include actions to adjust operation of one or more elements within a network.

In FIG. 4, the sensing engine 112 is operated within the SMO 110. In some cases, the sensing engine 112 can be operated within the RIC 108 in a similar manner to operating within the SMO 110. The SMO 110 can use data access—such as debug ports or an E2 agent—on at least one of the RU 102 or the DU 104 to obtain data. Obtained data can include information corresponding to a complex baseband representation of a received RF data. The information can include time or frequency domain IQ data. The SMO 110 can support sensing of radio activity using data provided by the RU 102 and the DU 104. Processing and responsive actions can include actions performed by the SMO 110, such as adjusting operation of one or more elements within a network.

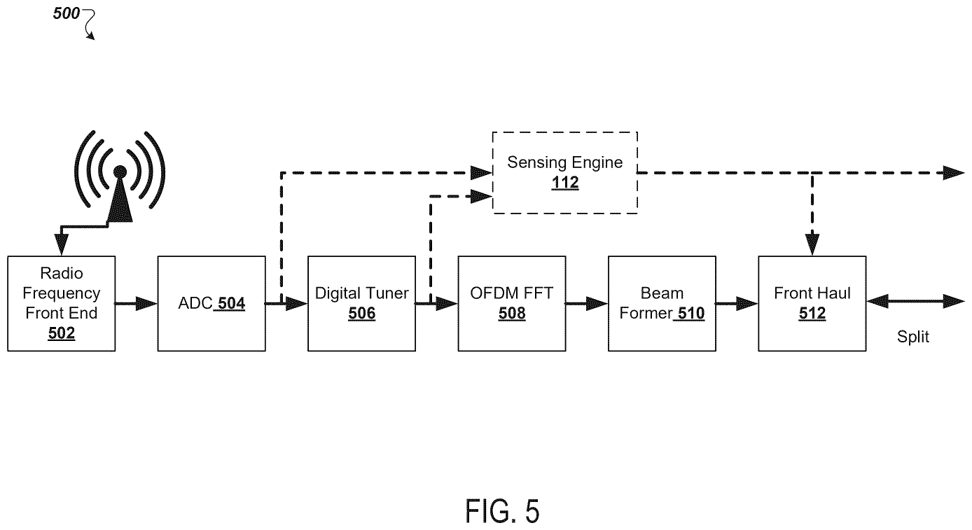

FIG. 5 shows an example process flow 500 of integrating RF sensing in an RU receiving path. In some cases, sampling parameters of a neural RF sensor can be tailored to optimize use of available compute resources—e.g., in a field-programmable gate array (FPGA) or other processor of an element, such as the RU 102 of FIG. 1. The sensing engine 112 can include one or more neural RF sensors. Processing for the sensing engine 112 can include an L1 baseband processor. Parameters can be used to reduce operation cost, reduce power consumption, reduce fronthaul bandwidth, or a combination of these among other effects. While full-rate IQ data from RF receivers on an RU can require 10 or 25 gigabit ethernet (GbE) for transport back to other network elements, RU based detection and classification can rely on low bandwidth (e.g., in order of kbps) to convey the resulting data, such as metadata, that includes detection events. Systems using such conveyance can reduce transport bandwidth requirements by orders of magnitude. Such systems can also improve the ease of scalability across a network, e.g., to thousands of sensing locations.

With every RU sensor, spatial coverage can be more complete as compared to a more limited sensor deployment. More complete spatial coverage can enable more efficient use of the limited electromagnetic spectrum for wireless communication signals. Such coverage can further help manage spectrum sharing, e.g., to avoid interference by users sharing a spectrum space on incumbent users of the space. The techniques described herein can enable a range of SMO, RIC, CU, or DU scheduler-driven interference mitigation policies, such as dynamic blanking of 5G signals to beam steering or nulling to protect incumbent users while minimizing the impact on capacity of a 5G network.

The process 500 can be implemented by one or more elements of the system 100, such as the RU 102. The process 500 includes receiving a radio signal using a RF front end 502. The process 500 includes using an analog-to-digital converter (ADC) 504 to digitize the received signal. The process 500 includes at least one of: providing the digitized version of the received signal to the sensing engine 112, providing the digitized version of the received signal to a digital tuner 506, or providing the digitized version of the received signal to both the sensing engine 112 and the digital tuner 506. The digitized version of the received signal can be information corresponding to the complex baseband representation of the received RF data. The digital tuner 506 can select a signal from a broader digitized spectrum.

The sensing engine 112 can receive data from the ADC 504, the digital tuner 506, or a combination of these. Data from the ADC 504 can be less than data from the digital tuner 506, e.g., because the digital tuner 506 can act as a filter to reduce the amount of data initially output by the ADC 504. Providing less data to the sensing engine 112 can simplify one or more processing operations performed by the sensing engine 112—e.g., simplifying one or more ML model architectures. Providing more data to the sensing engine 112 can improve accuracy of generated output, e.g., compared to providing less data. Providing more data can introduce more latency compared to providing less data.

In some cases, an amount of data provided to the sensing engine 112 is dynamic. For example, the RU 102, or another element of the system 100, can perform operations to determine an amount of data to provide to the sensing engine 112—e.g., based on one or more environmental factors. Environmental factors can include a processing load of an operating unit of the sensing engine 112, such as the RU 102 or other element. Environmental factors can include a time of day, weather, location, installed equipment, historical RF data, or a combination of these among others. In some cases, one or more ML models can be used to determine an amount of data provided to the sensing engine 112. In some cases, scheduling or sampling can be used to adjust a rate at which the sensing engine 112 runs, e.g., sampling at real-time data rates, periodic observations, aperiodic observations, or triggered observations. A rate can be adjusted by various rules, schedules, or messages over network interfaces such as C-Plane/M-plane, fronthaul, O1, or similar. In some cases, to aid in maintaining an electrical grid, providing less data can be selected when load of an electrical grid in an area where processing occurs is higher compared to when the load is lower. Providing less data can reduce an amount of electricity used in processing, e.g., using one or more ML models of the sensing engine 112. In some cases, sensing can be performed at low sampling rates (e.g. 1 Hz, 1/min) when in normal operation, at high load, or when power and computer are constrained. Sampling rates can be adjusted in response to one or more detected conditions. For example, sampling rates can be increased to 1000 Hz or higher. In some cases, sampling rates can be increased when considering more near-real-time operation, e.g., to debug or diagnose an ongoing radio air interface performance, contention, or co-existence condition, when triggered in response to a detected condition, or when more computational or power resources are detected to be dedicated to a given sensing task. In some cases, changes or observations can be triggered by changes in network KPIs, such as average cell modulation and coding scheme (MCS), received signal power, received interference power, average throughputs, average packet drop rates, retransmission rates, or a combination of these.

Processing of the process 500 can include an OFDM FFT 508 processing output from the digital tuner 506, a beam former 510 processing output from the OFDM FFT 508, and a front haul 512 processing output from the beam former 510. This sequence of the process 500 can perform signal processing—e.g., to receive and decode information included in RF signals. Beamformed data can be provided to one or more additional processing units, such as a DU 104, to extract information from the processed RF signal.

Output from the sensing engine 112 can include one or more signal detections. The output can be compact—e.g., kilobytes per second rather than gigabytes per second. Compactness can allow the detections of the sensing engine 112 to be sent to other elements for further processing, or action, such as interference mitigation or coexistence mechanisms while maintaining bandwidth within a threshold level of usage over interfaces that connect the various processing elements, such as the elements of FIG. 1. Such interfaces may have limits over how much data can be sent at any given time. By generating a compact representation of one or more signal detections, the sensing engine 112 can enable detection-based actions by a system, such as the system 100, while minimizing bandwidth disruptions over interfaces. The additional data provided by the sensing engine 112 can be used to improve sharing of limited RF spectrum between one or more devices.

Systems providing network-wide RF awareness can be used for various applications—e.g., instead of, or in addition to, spectrum sharing. Applications can improve a range of multivendor applications, which can enhance RAN operations, efficiency, or automation. Applications can include one or more of: dynamic spectrum sharing—e.g., enhanced coexistence among commercial and public sector users, to help increase utilization of frequency bands, such as the U.S. 3.1-3.45 GHz Band, 7 GHz or other global bands; enhanced carrier analytics—e.g., real-time interference detection or localization to improve network reliability, reduce latency or delays due to network issues, reduce truck rolls or operations and maintenance costs; automated private 5G spectrum operations—e.g., 5G spectrum monitoring in industrial environments, including unlicensed or electromagnetic interference (EMI) detection, with reduced latency, improved accuracy, and use of existing infrastructure to reduce setup time and cost; wireless security—e.g., wireless threat monitoring, access control, or anomalous activity alerts; localization—e.g., angle of arrival (AoA) or timing information can be augmented to locate an interfering signal, such as when unauthorized signals of interest or interference are detected on multiple antenna elements or multiple RUs. Unauthorized signals can include signals transmitted by bad actors. Unauthorized signals can include signals transmitted by devices that are not associated with one or more identifiers of authorized devices. Unauthorized signals can include signals from authorized or unauthorized devices, such as a signal of a type, transporting particular data, sent within a particular window of time, or a combination of these among others. Unauthorized signals can include signals from unauthorized base stations, malicious wireless cyber toolkit attempting jamming, injection, or manipulation of connectivity. Unauthorized signals can include a wide range of emitters, for instance in industrial settings, emissions from power systems, welders, robots, heaters, or other industrial systems can produce EMI which can degrade a range of wireless communications and sensing capabilities in the area if not detected and mitigated.

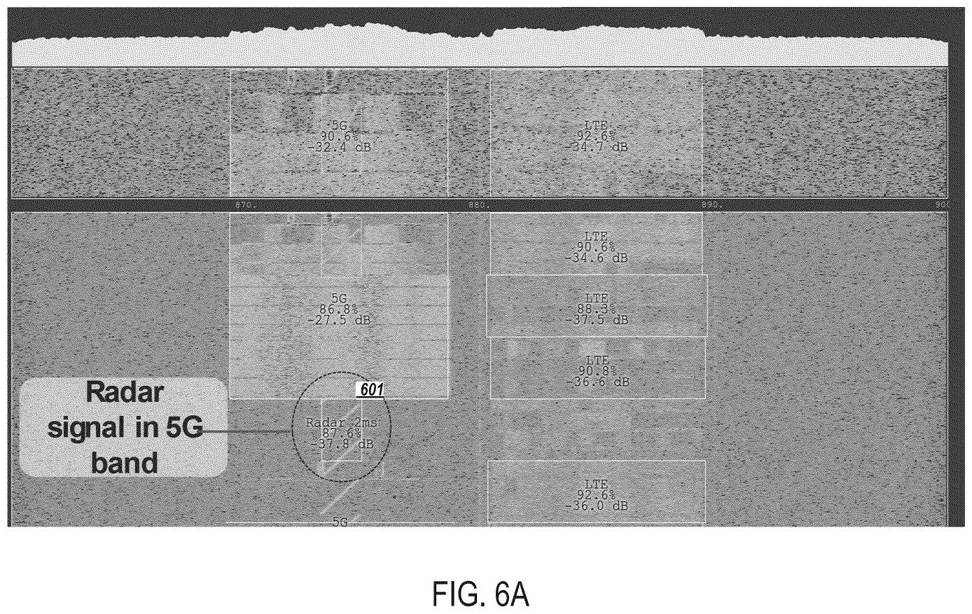

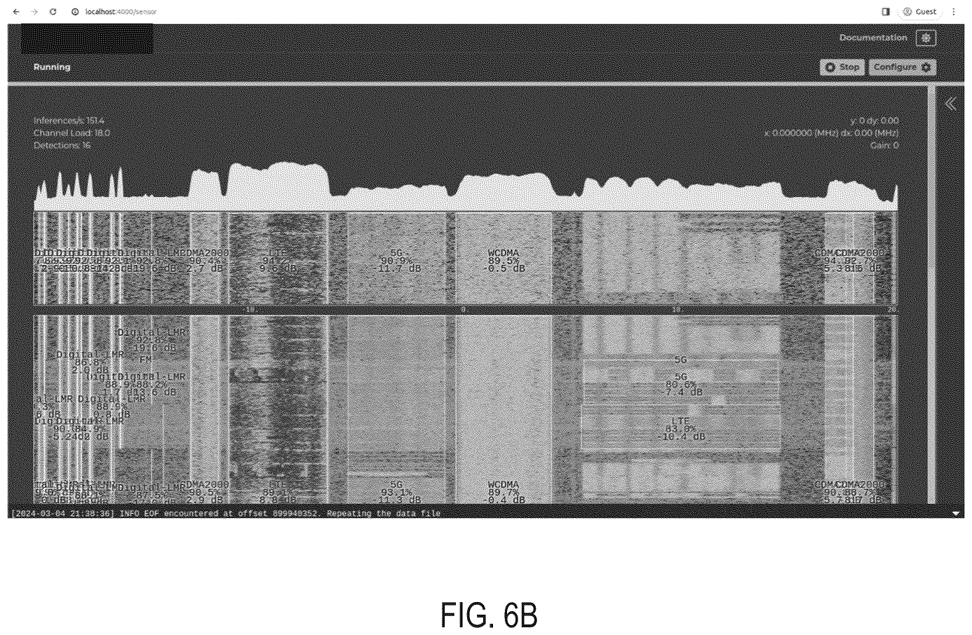

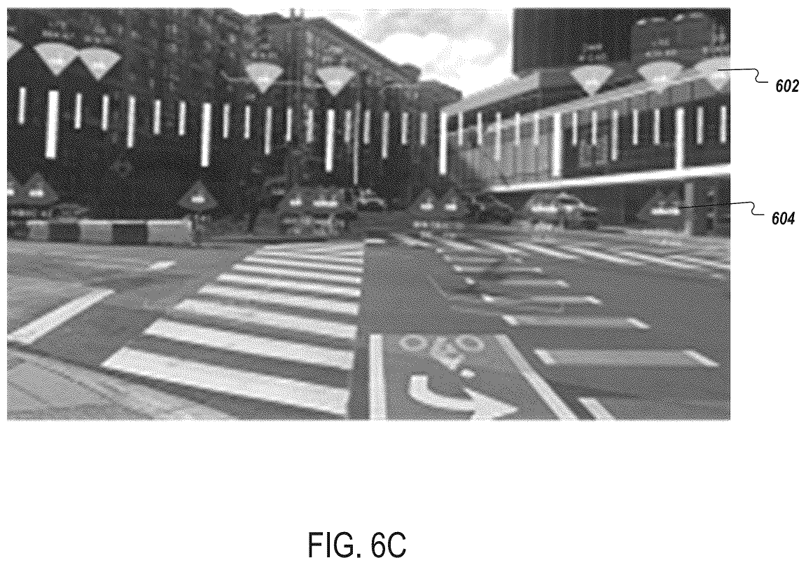

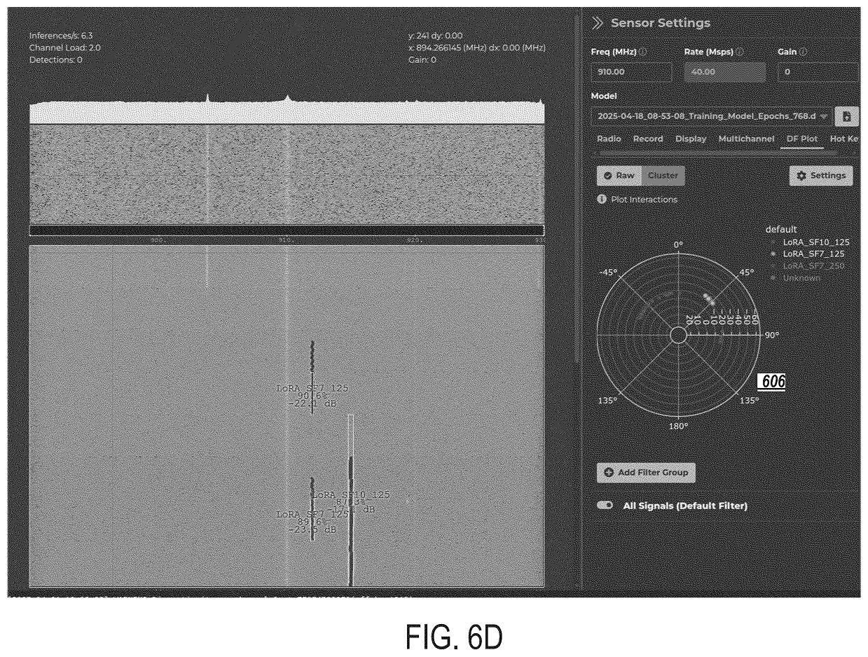

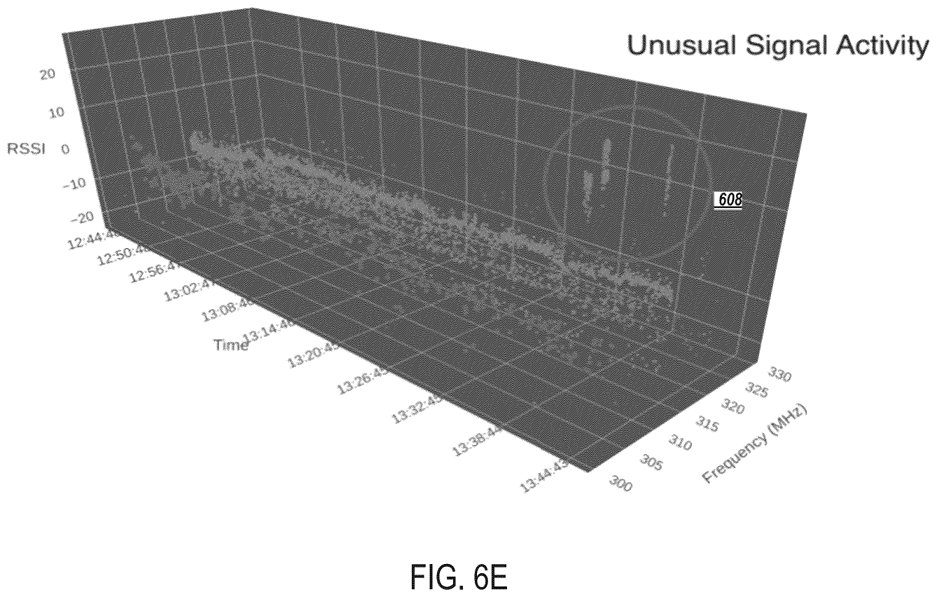

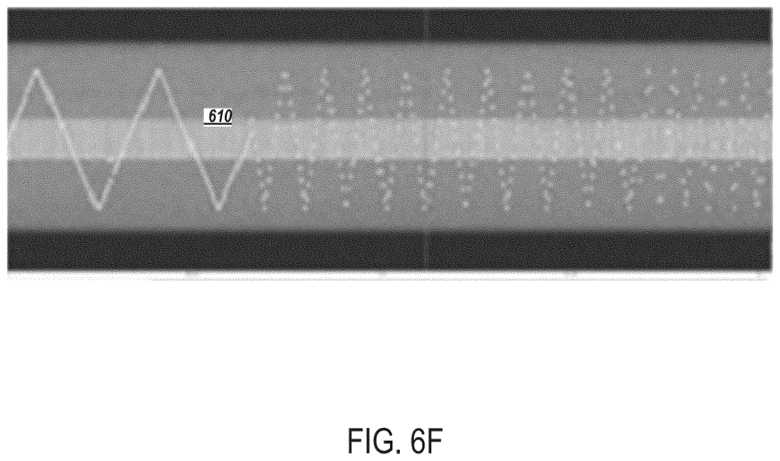

The techniques described herein include spectrum sensing. Spectrum sensing can be used to detect radio signals from various wireless communications, such as AI-native. Spectrum sensing can be useful for cyber security applications and in 5G or 6G applications. Example visualizations of spectrum sensing tools of one or more implementations that can use the techniques described in this disclosure are shown in FIGS. 6A-F. The spectrum sensing tools include tools for data curation and model training, model deployment, localization, and classification.

In some implementations, spectrum sensing tools include one or more ML software applications—e.g., ML models that can add RF awareness to a range of software defined radios, radio systems, test and measurement devices or other receivers, such as wideband receivers. Described techniques can use customizable neural networks, e.g., to provide real-time identification, classification, or localization of known or unknown RF signals, automated alerting and reaction, or open standards-based descriptions of signal activity. In some implementations, the disclosed implementations of spectrum sensing tools also include one or more of the following features: (i) a development platform to curate, label, train, test, or customize RF data and AI models built on neural networks; (ii) efficient, high-performance, processor-agnostic signal detection and classification runtime library of ML models; (iii) a centralized repository to store, search, manage or share pre-trained and custom neural spectrum sensing models in one secure location, or to replicate this on a network, such as a repository that is stored in a server or a local storage device.

FIG. 6A shows a graphical user interface (GUI) for detection of radio activity. In this case, a signal 601 in a 5G band is detected. The signal 601 can be detected using techniques described, e.g., using the sensing engine 112. For example, an element operating the sensing engine 112 can detect a signal and, in response to detecting the signal, provide a representation of the signal detection. The representation can include a spectrum of RF data—e.g., received from one or more RUs. The representation can include an indicator for one or more detected signals. The indicators can include information related to the detected signal, e.g., at least one or more of a frequency, time, amplitude, or a confidence threshold from one or more models used to detect the signal.

FIG. 6B shows a GUI for signal classification. Similar to FIG. 6A, FIG. 6B includes data plotted in time and in frequency. Signal indicators, represented as boxes, can be overlayed on the plotted time and frequency data to indicate one or more detected signals. Signals can be classified, e.g., as 5G, LTE, WCDMA, or other signals. Information can be represented numerically or graphically. For example, amplitude of RF data can be represented using numerical annotation or graphically—e.g., by the peaks and valleys above the plotted time and frequency data. Color can be used for signal information—e.g., red can indicate higher signal power compared to blue.

FIG. 6C shows a GUI for spatial signal awareness. The GUI can be presented on a wearable or mobile device. The device can be an augmented reality (AR) or virtual reality (VR) device. Indicators can show information related to one or more detected radio signals within an area. For example, data indicating a data uplink or downlink can be represented. Signals 602 and 604 are shown in the example of FIG. 6C as triangles. Other shapes or symbols can be used. The view of FIG. 6C shows a street corner where a user can view the device, e.g., a smartphone or wearable AR/VR headset, and see information indicating one or more detected radio signals. The information can be generated by the sensing engine 112. Presentation of the information can be a result of the sensing engine 112 transmitting one or more data signals to a connected component—such as the SMO 110 or other device for displaying relevant information on a device.

FIG. 6D shows a GUI for signal localization. The GUI includes an indicator 606. The indicator 606 can represent distance and direction to or from a detected radio transmitter. The sensing engine 112 can be used to detect one or more radio signals and provide data for generating the GUI of FIG. 6D—including a distance or direction to a transmitter.

FIG. 6E shows a graphical representation of unusual signal detection. Unusual activity 608 corresponds to one or more detected signals—e.g., detected using the sensing engine 112—that are atypical for a given environment, location, or a particular detector. In some cases, an element operating using data from the sensing engine 112 can determine one or more unusual signals. For example, the SMO 110 can receive data from the sensing engine 112. The data can include one or more radio signals. The SMO 110 can use the received data, one or more historical data signals, or one or more trained models, to determine if one or more signals of the detected signals are unusual. In some cases, the SMO 110, or other operating unit can provide a graphical representation to a user. A representation can include a plot similar to the one shown in FIG. 6E or a different type of visualization. A plot can be included in a GUI, such as the GUIs of FIG. 6A-D.

FIG. 6F shows a graphical representation of training a model. The model can be one used in the sensing engine 112. A jagged line 610 of FIG. 6F shows a training process from a model being not trained, or partially trained, to a model being fully trained. A model fully trained can satisfy one or more confidence thresholds while processing one or more items of input data. In some cases, a representation similar to FIG. 6F can be provided to a user of a sensing system when training one or more models that can be used in the sensing engine 112.

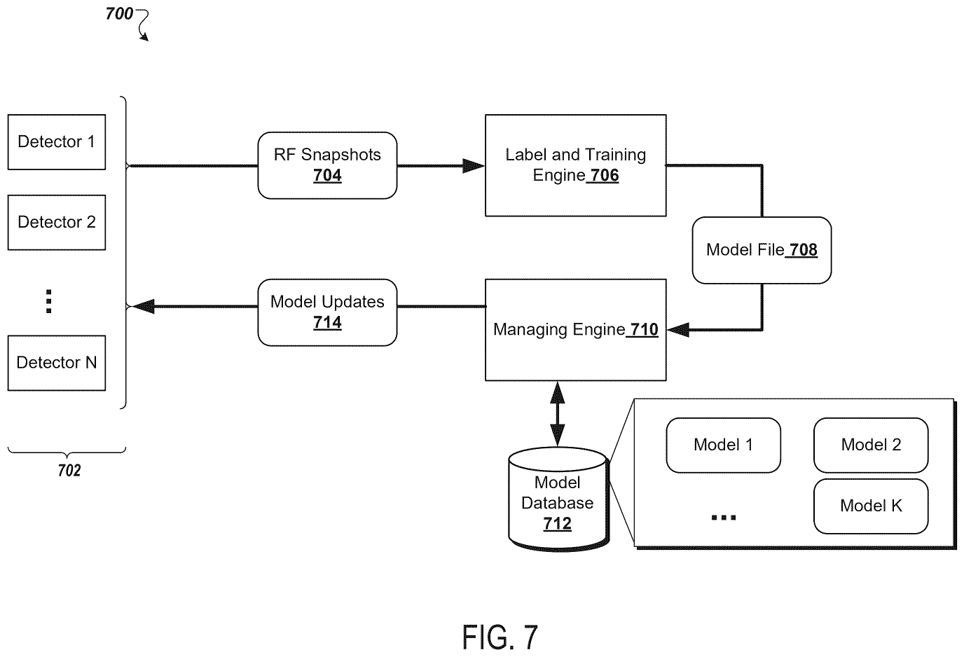

FIG. 7 shows an example system 700 for updating one or more ML models—e.g., for use in detecting radio activity, such as in the sensing engine 112. The system 700 includes detectors 1-N 702 that can detect radio activity, where N can be any number. A detector can be an element of the system 100, such as the RU 102. Processing, as shown in FIG. 7, can then be performed by the RU 102, or another element, such as the DU 104, the CU 106, the RIC 108, or the SMO 110. The processing includes processing RF snapshots 704 using a label and training engine 706, storing a generated model file 708 by a managing engine 710 in a model database 712, and providing model updates 714—e.g., for one or more ML models of the detectors 1-N 702.

The RF snapshots 704 can include spectrum data, metadata, identified signals, interference, directional information, or a combination of these. In some cases, new signals—e.g., that have not yet been added to a training dataset—are provided to the label and training engine 706. In some cases, if a detector detects a signal but identifies a classification or the signal with a confidence value that satisfies a threshold, or detects a signal with a confidence value that satisfies a threshold, the detector can provide corresponding RF snapshots to the label and training engine 706. The thresholds can indicate that the detector has not be trained on the signal—e.g., because the confidence value is absolutely or relatively low.

The label and training engine 706 can generate the model file 708. The model file 708 can be on the order of a megabytes or other storage size. The model file 708 can include one or more of a model architecture, trained weights or parameters, hyperparameters, preprocessing information, metadata, optimizer state, or loss function or evaluation metrics.

The managing engine 710 can store the model file 708 in the model database 712. The model database 712 can include a number of different models, such as models 1-K where K can be any number, and can be the same or different than N. In some cases, models can be configured for detecting specific types of signals or detecting signals in particular areas. A detector can use one or more models to detect one or more signals. A detection can include running input data through one or more specialized networks to obtain output from the one or more networks. The managing engine 710 can provide the model updates 714 to at least one of the detectors 1-N. The managing engine 710 can provide some updates to all or some of the detectors 1-N.

In some cases, the managing engine 710 uses information of the detectors 1-N to determine which detectors are to be updated with which updates. For example, the managing engine 710 can provide models that specialize for a specific location, or environment type, to detectors that operate within a threshold distance of the specific location or the environment type. Environment type can include weather, climate, or geographical formations. Location can include a city, county, state, or country. The managing engine 710 can receive signals from one or more of the detectors 1-N. The signals can be processed or passed-on by one or more intermediary devices or directly sent to a device that operates the managing engine 710. The signals can indicate information of the detectors 1-N—e.g., a location or environment type within which a given detector operates.

The managing engine 710 can generate and transmit a signal that encodes the one or more model files or other update information in the model updates 714 to one or more of the detectors 1-N. The signal can be configured to cause at least one of the detectors 1-N to update an existing model, add a model, or adjust operation of a model of the detector. The updated set of one or more models of a detector can then be used for processing one or more signals received subsequent to the receipt of the model updates 714.

Described techniques can be used in spectrum sensing tools. Techniques can enable developers to create, deploy, or manage AI models, e.g., for sensing a range of communications and 5G systems. The spectrum sensing tools can run on one or more graphics processing units (GPUs, e.g., NVIDIA™ GPUs), field-programmable gate arrays (FPGAs), accelerated processing units (APUs), neural processing units (NPUs), tensor processing units (TPUs), digital signal processors (DSPs), x86 or Arm processors and can come with native support for a wide range of software defined radios (SDRs). This can help ensure broad compatibility and rapid integration with equipment across the wireless industry.

The disclosed spectrum sensing tools can use AI-driven signal detection and classification technology to enhance reliability and security of wireless communications for various organizations or sensing applications. In some implementations, these tools can use a customizable deep learning training pipeline that leverages neural networks highly tuned for RF sensing, using an AI model architecture, to support a broad range of signal types, including LTE, 5G, Wi-Fi, Bluetooth, and more, with the flexibility to add custom signals. These spectrum sensing tools can detect and classify signals with high accuracy across a 400-500 MHz of bandwidth in as little as 1-2 milliseconds—approximately 1000× faster than many conventional methods.

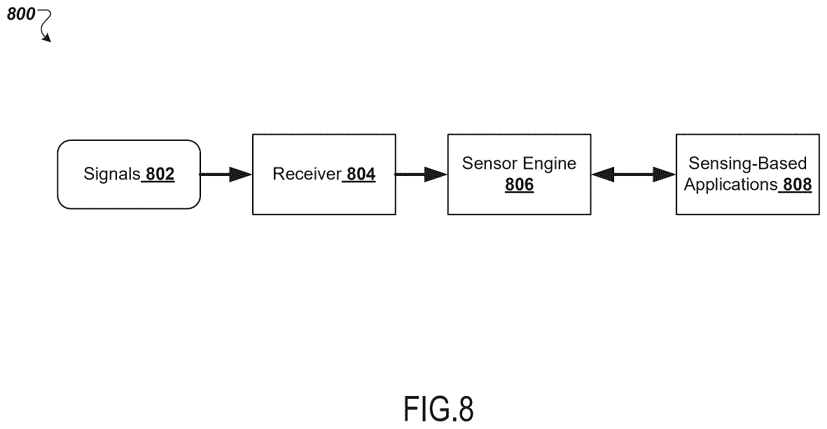

FIG. 8 shows a process 800 for signal detection. The process 800 includes receiving signals 802—e.g., RF signals, optical signals, or other communication signals—using the receiver 804. The received signals can then be processed by the sensor engine 806. The sensor engine 806 can include the sensing engine 112. The sensor engine 806 generates output data indicating a detected set of one or more signals, such as RF signals, optical signals, or other communication signals. The generated data of the sensor engine 806 can be used for one or more sensing-based applications 808—such as at least one of spectrum sharing, wireless security, wireless threat monitoring, drone detection or anomalous activity alerting, signal classification, signal localization, spatial awareness, or analytics. The sensing-based applications 808 can include providing visualizations or other output on a display of a device, such as a smartphone, computer, VR/AR device, or a combination of these. Output can include visual or non-visual data, such as audio or vibration feedback.

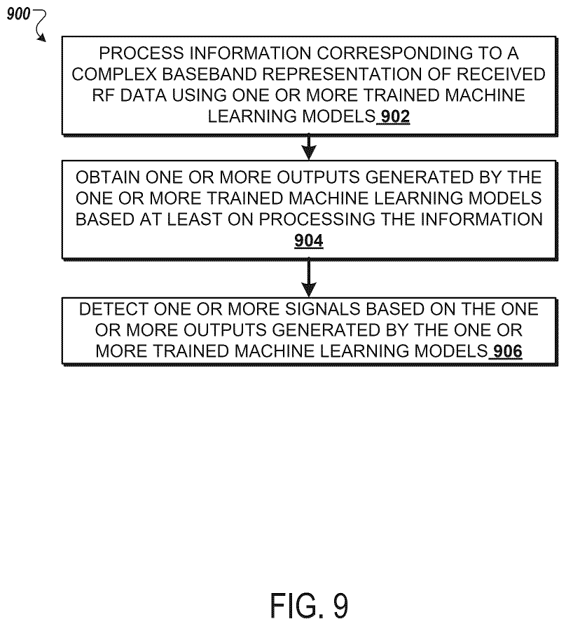

FIG. 9 is a flowchart of an example process 900 for detecting signals. For convenience, the process 900 will be described as being performed by a system of one or more computers, located in one or more locations, and programmed appropriately in accordance with this specification. For example, a signal detecting system, e.g., the signal detecting system 100 of FIG. 1, appropriately programmed, can perform the process 900.

The process 900 includes processing information corresponding to a complex baseband representation of received RF data using one or more trained machine learning models (902). The information corresponding to the complex baseband representation of the received RF data can be generated by a radio unit that is configured to sampled received RF data. The information can be processed, at least in part, by one or more suitable system elements, such as the RU 102, the DU 104, the CU 106, the RIC 108, or the SMO 110. In some cases, a radio unit, such as the RU 102, can be configured to generate an in-phase and quadrature data stream as the information corresponding to the complex baseband representation of the received RF data.

The process 900 includes obtaining one or more outputs generated by the one or more trained machine learning models based at least on processing the information, e.g., corresponding to the complex baseband representation of the received RF data (904). For example, the sensing engine 112 can include one or more ML models. The sensing engine 112 can obtain output from one or more models. In some cases, the processing engine 208 of the SMO 110 can obtain one or more outputs of the sensing engine 112.

The process 900 includes detecting one or more signals based on the one or more outputs generated by the one or more trained machine learning models (906). For example, the sensing engine 112 can detect one or more signals using one or more ML models.

The process 900 can be performed, at least in part, by at least one of a radio unit, a distributed unit, a control unit, a radio access network intelligent controller, or a service management and orchestration element, such as the RU 102, the DU 104, the CU 106, the RIC 108, or the SMO 110.

In some cases, the process 900 includes, in response to detecting the one or more signals based on the one or more outputs generated by the one or more trained machine learning models, adjusting operation of one or more elements within a communication network. In some cases, adjusting operation of the one or more elements within the communication network includes performing one or more interference mitigation or coexistence mechanisms. One or more interference mitigation or coexistence mechanisms can include adjusting at least one of the following: power levels; antenna parameters, such as pointing, tilt, or active elements; beam parameters, such as beam direction, shape, element values, sub-array pointing, or a combination of these; null parameters, such as null direction, null depth, total beam pattern, or a combination of these; resource scheduling/mMIMO resource scheduling, such as time, frequency, beam, user pairing, assignments, power levels allocated, MCS allocations, encoding modes, or MIMO settings/layer counts/MIMO modes; reduction of other emitters power level or refinement of pointing/beams; frequency assignment/planning; sub-band assignment/coloring; handoff to other sectors/bands/slices; vacating the band; codebook updates, such as precoding/beam codebooks/among others; changing receiver modes, e.g. neural receiver, IRC receiver, SIC receiver, additional SIC cancellation of interferes; changes in receiver hardware choices, e.g. gain/attenuation/filtering/channelization/bit-resolution settings, power settings, elements enabled; changes to schedule policies or other RIC type policies.

In some cases, adjusting operation of the one or more elements within the communication network comprises adjusting a transmitting or receiving device that transmits or receives data with a range of 3.1 to 3.45 GHz.

In some cases, the process 900 includes providing an indication of the detected one or more signals to one or more connected devices. The process 900 can include providing a visual or non-visual representation of the detected one or more signals to one or more devices that are communicably coupled to at least one of a radio unit, a distributed unit, a control unit, a radio access network intelligent controller, or a service management and orchestration element. In some cases, providing the visual representation of the detected one or more signals to the one or more devices includes presenting, on a graphical user interface of the one or more devices, numerical or non-numerical indicators of the detected one or more signals. In some cases, presenting on the graphical user interface of the one or more devices the numerical or non-numerical indicators of the detected one or more signals includes displaying, on the graphical user interface, an image that includes a region with indicators situated within the region corresponding to at least one of the detected one or more signals—e.g., an example of which is shown in FIG. 6D, where the region includes the indicator 606 which is rounded.

In some cases, providing the visual representation of the detected one or more signals to the one or more devices includes providing an estimated spatial location of a transmitting device that transmitted at least one of the detected one or more signals. In some cases, providing the estimated spatial location of the transmitting device that transmitted at least one of the detected one or more signals includes providing the estimated spatial location as an indication to an augmented or virtual reality wearable device. For example, detection or localization information can be provided to help personnel identify where a signal is coming from, which can be used to help fix network issues more rapidly.

In some cases, the process 900 includes, in response to detecting the one or more signals based on output of the one or more trained machine learning models processing the complex baseband representation of the received RF data, controlling access to one or more wireless networks or devices—e.g., blocking transmissions from one or more devices to a given network or blocking transmissions from one or more devices to one or more other devices. Controlling access to one or more networks or devices can include: blocking access, e.g., based on location or signal properties such as an identifier; alerting humans or security systems to respond physically; alerting other radio systems, e.g., using a frequency coordinator, such as using a frequency coordinator, such as software as a service (SAAS), to signal other networks or radio systems to make adjustments; adding spatial filters to block offending transmissions; configuring a base station to ignore signals, such as random access channel (RACH) from an offender; emitting radio signals to interact with an offending signal—e.g. responding to a drone signal or other autonomous platform—to perform one or more operations, such as sending protocol messages or jamming. In some cases, legal authorities might require alerting humans, e.g., security or enforcement officials as to where, how, and/or what is being done so that they can intervene.

In some cases, the process 900 includes, in response to detecting the one or more signals based on output of the one or more trained machine learning models processing the information corresponding to the complex baseband representation of the received RF data, generating and transmitting one or more alerts to a connected device. For example, an alert could indicate one or more detected signals or information related to the signals. An alert can include alerts for unauthorized devices or signal transmissions. Unauthorized devices or signal transmissions can include devices or signals that are not expected using one or more models trained to predict one or more devices or signals operating within a region. Unauthorized devices or signal transmissions can include devices that have not been registered for a given transmission or signal transmissions that are not of a known type or format. Alerts can include wireless threat monitoring, access control, or anomalous activity alerts.

In some cases, the process 900 includes detecting one or more of angle of arrival or timing information of the detected signals, e.g., based on the one or more outputs generated by the one or more trained machine learning models processing the information corresponding to the complex baseband representation of the received RF data. In some cases, detection of at least one of angle of arrival or timing information of the detected signals can occur in response to a determination that a detected signal satisfies one or more criteria for further processing. Further processing of a detected signal can be performed if a processing device determines that one or more criteria are satisfied. The one or more criteria can include: unauthorized signals; signals from potentially threatening or abnormal locations or platforms or users—e.g. airborne; deviations greater than a threshold compared to a normal state of environmental communications; signals transmitted from outside authorized areas or premises; signals transmitted from devices that are not authorized for a certain geographical area.

In some cases, the process 900 includes determining that the detected one or more signals correspond to unauthorized signals and, in response to determining that the detected one or more signals correspond to unauthorized signals, detecting one or more of angle of arrival or timing information of the detected signals based on the one or more outputs of the one or more trained machine learning models processing the information corresponding to the complex baseband representation of the received RF data. In some cases, a system, such as the system 100 of FIG. 1, can detect an unauthorized signal. Detecting an unauthorized signal can include using one or more ML models that are trained to detect unauthorized signal using a corpus of training data that includes one or more known unauthorized signals. Detecting an unauthorized signal can include comparing one or more detected signals—or features of signals, such as location, metadata of signals, protocols, or other features—to one or more stored data items. The data items can be maintained in a database indicating whether or not the stored items indicate an authorized or unauthorized signal. The system can perform one or more comparisons between maintained data, e.g., stored in a computer database, with one or more detected signals or features of one or more signals.

Detecting whether or not a signal is authorized can include detecting an emanating region corresponding to a location where a transmitting device is located. The emanating region can be an authorized or unauthorized area. The system can detect a signal emanating from a specific geographic region—e.g., an unauthorized area, ground-based system appearing in the sky, or outside of a secure area. Detecting whether or not a signal is authorized can include detecting a feature of a signal, such as usage pattern, or movement. The system can detect whether a signal is being used outside of a standard usage pattern, which can be a feature that indicates the signal is unauthorized. The system can detect whether a transmitting device is moving at unexpected speeds or in unexpected ways which can indicate the signal is unauthorized. The system can detect a number of signals from a given location or region and determine, using one or more values representing an expected number of signals from the location or region, whether the detected number of signals is within a range of expected signal activity. If the detected number of signals is outside a threshold of the expected signal activity, the system can determine one or more of the detected signals are unauthorized. An example of an unauthorized signal could include a drone or plane connected to a cellular network without authorization which might pose a threat, jamming, or unauthorized access of various communications system from airborne platforms or atypical locations or directions. Signals arriving at specific timing can be indicative of malicious behavior, e.g., uplink transmissions in a cellular system that are not properly time, or frequency, aligned might indicate an authorized signal, such as a malicious or accidental transmission of signaling by various parties. Transmissions can be properly aligned using suitable network access and time synchronization routines.

In some cases, the process 900 includes providing information corresponding to a location or environment and, in response to providing the information corresponding to the location or environment, receiving an update that corresponds to the location or environment from a stored database of model updates. The information corresponding to a location or environment can indicate a location or environment of a detected signal—such as a location or environment of a device operating within a sensing threshold distance from the sensing engine 112. Updates can be provided as described from a database of models. An example updating process is shown in FIG. 7 where the model updates 714 are provided to the detectors 702. In some cases, a system, such as the system 700 of FIG. 7, uses information that indicates a type of environment or geographic location to provide an update for one or more models. In some cases, a device can receive a model update that is specific to its location or type of environment in which it receives or transmits signals. Information used to provide updates can include a location of a receiver, a location of an emitter, one or more power levels of one or more transmitted signals, one or more propagation properties, a location of clutter, obstruction, or reflectors. Information used to provide updates can include known locations of one or more receivers which may not emit—e.g., a satellite ground station, a location of another base station or user, or high powered emitters. Information used to provide updates can be used to select, from the model database 712, a suitable update for a given device. An update can include model parameters that are specifically configured for an environment or region where the device operates. The model parameters can be generated using one or more training data items from the environment or region, captured from the device to be updated or another device.

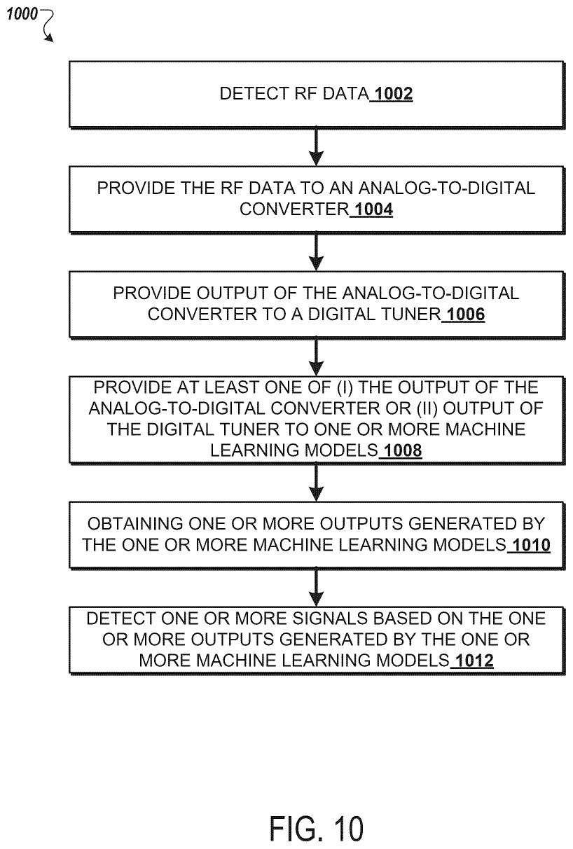

FIG. 10 is a flowchart of an example process 1000 for detecting signals. For convenience, the process 1000 will be described as being performed by a system of one or more computers, located in one or more locations, and programmed appropriately in accordance with this specification. For example, a signal detecting system, e.g., the signal detecting system 100 of FIG. 1, appropriately programmed, can perform the process 1000.

The process 1000 includes detecting RF data, e.g., using a radio frequency (RF) front end (1002). For example, the RF front end 502 shown in FIG. 5 can detect RF data.

The process 1000 includes providing the RF data to an analog-to-digital converter (1004). For example, the RF front end 502 can provide RF data to the ADC 504.

The process 1000 includes providing output of the analog-to-digital converter to a digital tuner (1006). For example, the ADC 504 can provide a digitized version of a received signal to the digital tuner 506.

The process 1000 includes providing at least one of (i) the output of the analog-to-digital converter or (ii) output of the digital tuner to one or more machine learning models (1008). For example, output of at least one of the ADC 504 or output of the digital tuner 506 can be provided to the sensing engine 112. The sensing engine 112 can include one or more ML models.

The process 1000 includes obtaining one or more outputs generated by the one or more machine learning models, e.g., in response to providing at least one of (i) the output of the analog-to-digital converter or (ii) output of the digital tuner to the one or more machine learning models (1010). For example, the sensing engine 112 can generate output that indicates one or more signal detections.

The process 1000 includes detecting one or more signals based on the one or more outputs generated by the one or more machine learning models, e.g., processing at least one of (i) the output of the analog-to-digital converter or (ii) the output of the digital tuner (1012). For example, the sensing engine 112 can generate detection data that can be used internally, or within a connected system. The detection data can be used to enable detection-based actions by a given system, such as one or more mitigation or coexistence mechanisms.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising:
a radio unit;
a distributed unit; and
a service management and orchestration element,
wherein the radio unit is configured to sample a received radio frequency (RF) data to generate information corresponding to a complex baseband representation of the received RF data, and
wherein at least one of the radio unit, the distributed unit, a control unit, a radio access network intelligent controller, or the service management and orchestration element is configured to perform operations comprising:
process the information corresponding to the complex baseband representation of the received RF data using one or more trained machine learning models;
obtain one or more outputs generated by the one or more trained machine learning models based at least on processing the information corresponding to the complex baseband representation of the received RF data; and
detect one or more signals based on the one or more outputs generated by the one or more trained machine learning models.

2. The system of claim 1, wherein the operations comprise:
in response to detecting the one or more signals based on the one or more outputs generated by the one or more trained machine learning models, adjusting operation of one or more elements within a communication network.

3. The system of claim 2, wherein adjusting operation of the one or more elements within the communication network comprises performing one or more interference mitigation or coexistence mechanisms.

4. The system of claim 2, wherein adjusting operation of the one or more elements within the communication network comprises adjusting a transmitting or receiving device that transmits or receives data within FR1, FR2, or FR3.

5. The system of claim 1, wherein the operations comprise:
providing a visual or non-visual representation of the detected one or more signals to one or more devices that are communicably coupled to at least one of the radio unit, the distributed unit, the control unit, the radio access network intelligent controller, or the service management and orchestration element.

6. The system of claim 5, wherein providing the visual representation of the detected one or more signals to the one or more devices comprises:
presenting, on a graphical user interface of the one or more devices, numerical or non-numerical indicators of the detected one or more signals.

7. The system of claim 6, wherein presenting on the graphical user interface of the one or more devices the numerical or non-numerical indicators of the detected one or more signals comprises:
displaying, on the graphical user interface, an image that includes a region with indicators situated within the region corresponding to at least one of the detected one or more signals.

8. The system of claim 5, wherein providing the visual representation of the detected one or more signals to the one or more devices comprises:
providing an estimated spatial location of a transmitting device that transmitted at least one of the detected one or more signals.

9. The system of claim 8, wherein providing the estimated spatial location of the transmitting device that transmitted at least one of the detected one or more signals comprises:
providing the estimated spatial location as an indication to an augmented or virtual reality wearable device.

10. The system of claim 1, wherein the operations comprise:
in response to detecting the one or more signals based on output of the one or more trained machine learning models processing the complex baseband representation of the received RF data, controlling access to one or more wireless networks or devices.

11. The system of claim 1, wherein the operations comprise:
in response to detecting the one or more signals based on output of the one or more trained machine learning models processing the information corresponding to the complex baseband representation of the received RF data, generating and transmitting one or more alerts to a connected device.

12. The system of claim 1, wherein the operations comprise:
detecting one or more of angle of arrival or timing information of the detected signals based on the one or more outputs generated by the one or more trained machine learning models processing the information corresponding to the complex baseband representation of the received RF data.

13. The system of claim 1, wherein the operations comprise:
determining that the detected one or more signals correspond to unauthorized signals; and
in response to determining that the detected one or more signals correspond to unauthorized signals, detecting one or more of angle of arrival or timing information of the detected signals based on the one or more outputs of the one or more trained machine learning models processing the information corresponding to the complex baseband representation of the received RF data.

14. The system of claim 1, wherein the operations comprise:
providing information corresponding to a location or environment; and
in response to providing the information corresponding to the location or environment, receiving an update that corresponds to the location or environment from a stored database of model updates.

15. The system of claim 1, wherein the radio unit is configured to generate an in-phase and quadrature data stream as the information corresponding to the complex baseband representation of the received RF data.

16. A method comprising:
detecting, using a radio frequency (RF) front end, RF data;
providing the RF data to an analog-to-digital converter;
providing output of the analog-to-digital converter to a digital tuner;
providing at least one of (i) the output of the analog-to-digital converter or (ii) output of the digital tuner to one or more machine learning models;
in response to providing at least one of (i) the output of the analog-to-digital converter or (ii) output of the digital tuner to the one or more machine learning models, obtaining one or more outputs generated by the one or more machine learning models; and
detecting one or more signals based on the one or more outputs generated by the one or more machine learning models processing at least one of (i) the output of the analog-to-digital converter or (ii) the output of the digital tuner.

17. The method of claim 16, wherein detecting the RF data comprises:
detecting the RF data using a radio unit that includes an RF front end.

18. The method of claim 16, wherein providing at least one of (i) the output of the analog-to-digital converter or (ii) the output of the digital tuner to the one or more machine learning models comprises:
providing at least one of (i) the output of the analog-to-digital converter or (ii) the output of the digital tuner to a distributed unit, wherein the distributed unit operates the one or more machine learning models.

19. The method of claim 16, wherein providing at least one of (i) the output of the analog-to-digital converter or (ii) the output of the digital tuner to the one or more machine learning models comprises:
providing at least one of (i) the output of the analog-to-digital converter or (ii) the output of the digital tuner to a service management and orchestration element, wherein the service management and orchestration element operates the one or more machine learning models.

20. The method of claim 16, wherein providing at least one of (i) the output of the analog-to-digital converter or (ii) the output of the digital tuner to the one or more machine learning models comprises:
providing at least one of (i) the output of the analog-to-digital converter or (ii) the output of the digital tuner to a radio access network intelligent controller, wherein the radio access network intelligent controller operates the one or more machine learning models.

21. The method of claim 16, wherein providing at least one of (i) the output of the analog-to-digital converter or (ii) the output of the digital tuner to the one or more machine learning models comprises:
providing at least one of (i) the output of the analog-to-digital converter or (ii) the output of the digital tuner to a control unit, wherein the control unit operates the one or more machine learning models.
